(19) United States
(12) Patent Application Publication
(10) Pub. No.: US 2010/0053951 A1
(43) Pub. Date: Mar. 4, 2010

(54) LED FLOOR LAMP

(76) Inventors: Te-Hsuan HSIEH, Taichung County (TW); Yung-Fu TANG, Taichung County (TW)

Correspondence Address: Dr. BANGER SHIA;Int''l Patent Office of Bang Shia, 102 Lindencrest Ct, Sugar Land, TX, 77479-5201, US

(21) Appl. No.: 12/204,669

(22) Filed: Sep. 4, 2008

(51) Int. Cl. F21V 1/00

(52) U.S. Cl. 362/235

(57) ABSTRACT

An LED floor lamp comprises a main structure, a light shade and a light source, the main structure includes a rod and a base, and the light shade includes a reflecting surface, wherein the rod is fixed on the base, the light shade is mounted on a top end of the rod and the reflecting surface thereof faces upward, the light source is disposed in the light shade and consisted of a plurality of single-packaged light emitting diodes each with a power of more than 12 W. Therefore, the LED floor lamp can provide a high illumination while avoiding energy waste.

### BACKGROUND OF THE INVENTION

1. Field of the Invention

The present invention relates to a floor lamp, and more particularly to a LED (light emitting diode) floor lamp.

2. Description of the Prior Art

Since Edison invented electric light, people start to enjoy the variegated nightlife. When night falls, some people would like to decorate the house with several floor lamps for providing sufficient illumination and adding more life entertainments. However, conventional floor lamps always use halogen bulbs as theirs light source, however it has the following problems:

First, the halogen bulb is produced at a low cost, however, its energy conversion efficiency is also very low, and as a result, a lot of electric energy is converted into thermal energy, causing loss of energy. Besides, the halogen bulb contains halogen, so it obviously does not meet the user's requirement, due to the environmental concerns and the increase of electric charge.

Second, if using power-saving bulb as light source, it still can meet the user s demand since the power-saving bulb cannot be adjusted in luminance.

Third, the conventional bulb are fragile, it is inconvenient to transport, furthermore, it is likely to cause environmental and safety problems during the course of reclamation.

The present invention has arisen to mitigate and/or obviate the afore-described disadvantages.

### SUMMARY OF THE INVENTION

The primary objective of the present invention is to solve the abovementioned problems by providing a LED floor lamp. The LED floor lamp comprises a main structure, a light shade and a light source, the main structure includes a rod and a base, and the light shade includes a reflecting surface, wherein the rod is fixed on the base, the light shade is mounted on a top end of the rod with the reflecting surface facing upward, the light source is disposed in the light shade and consisted of a plurality of above 12 W single-packaged light emitting diodes. The LED floor lamp further comprises a light-adjustment device for controlling the wave color of the light emitting diodes.

Using the above 12 W single packaged LED as light source, the floor lamp of the present invention has the advantages of power saving, high power and long life as compared to the conventional bulbs.

### BRIEF DESCRIPTION OF THE DRAWINGS

FIG. 1 is a perspective view of a LED floor lamp in accordance with the present invention;

FIG. 2 is a top view of a LED floor lamp in accordance with the present invention; and

FIG. 3 is an exploded view of a LED floor lamp in accordance with the present invention.

### DETAILED DESCRIPTION OF THE PREFERRED EMBODIMENT

The present invention will be clearer from the following description when viewed together with the accompanying drawings, which show, for purpose of illustrations only, the preferred embodiment in accordance with the present invention.

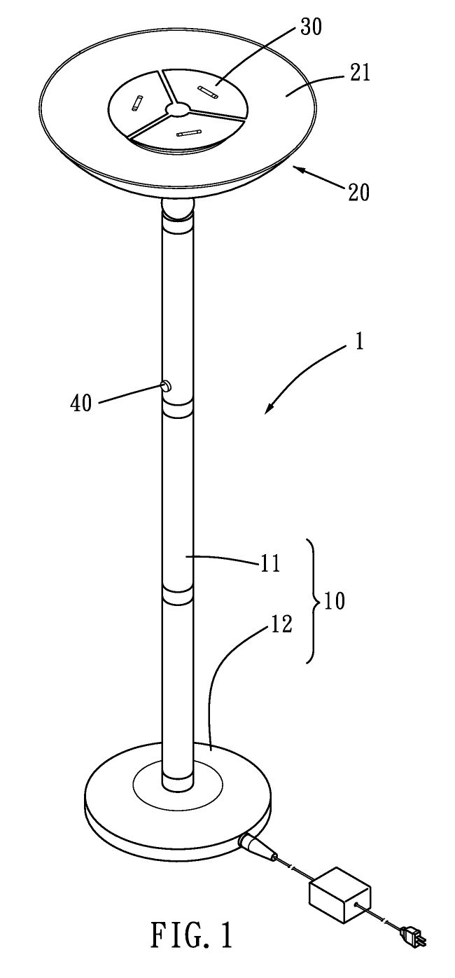

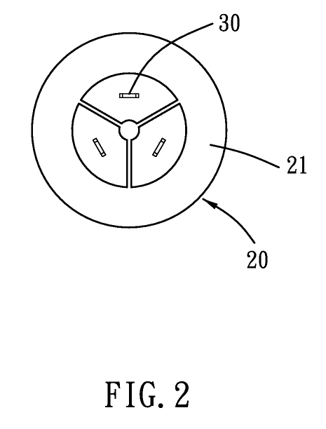

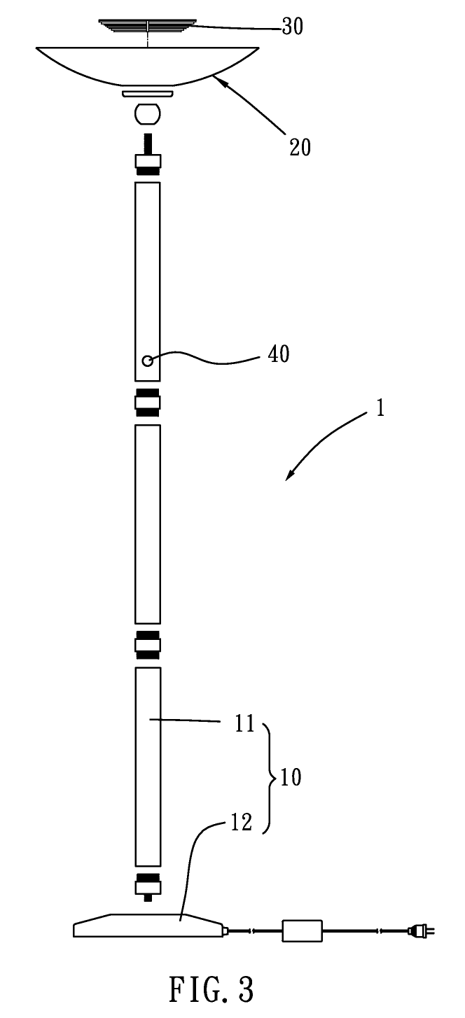

Referring to FIGS. 1-3, which are a perspective view, a top view and an exploded view showing a LED floor lamp in accordance with an embodiment of the present invention, wherein the LED floor lamp 1 comprises a main structure 10, a light shade 20, a light source 30 and a light-adjustment device 40. The main structure 10 includes a rod 11 and a base 12. The light shade 20 includes a reflecting surface 21. The rod 11 is fixed on the base 12, the light shade 20 is disposed on the top end of the rod 11 and the reflecting surface 21 of the light shade 20 faces upward, and the light source 30 is disposed in the light shade 20.

In this embodiment, the light source consists of more than three single-packaged (independently packed) LEDs each with a power of more than 12 W, the luminance of which equals that of a 200 W conventional halogen bulb, therefore, a lot of energy can be saved. In addition, the light-adjustment device 40 can adjust the color of the light wave of the LEDs so as to create various indoor atmospheres. Moreover, the floor lamp 1 can be connected to a DC (direct current) or AC (alternative current) power source, it is provided with an AC/DC converter when AC power source is used.

The LED floor lamp of the present invention is supposed to achieve the following functions and effects:

First, using the 12 W above single packaged LED as light source, the floor lamp of the present invention is more power saving than the conventional bulb, while its luminance is not less than the conventional bulb, therefore, it is practical and environmental friendly. Besides high power, power saving, long life and high luminance, the above 12 W single packaged LED further has the advantages of nice appearance and convenience of assembly, as compared to the conventional low power halogen bulb.

Second, LED is not easily broken when subjected to an external force, hence, it is more convenient to transport and reclaim than the conventional halogen bulb.

Third, the floor lamp is mainly used for local illumination; the light of the LED is directional, and thus substantially improving the illumination of the floor lamp.

Fourth, the floor lamp of the present invention is further provided with a light-adjustment device which is capable of creating various color tones, color temperatures and visual effects by cooperating with the different combinations of the LEDs, thus providing variegated indoor atmosphere.

Fifth, the floor lamp of the present invention can be used in various surroundings without being restricted by environmental factors, since it is suitable for DC and AC applications.

To summarize, the LED floor lamp of the present invention can provide a high illumination while avoiding energy waste and having the advantages of nice appearance, practicability, and environmental friendly.

While we have shown and described various embodiments in accordance with the present invention, it is clear to those skilled in the art that further embodiments may be made without departing from the scope of the present invention.

What is claimed is:

1. A LED floor lamp comprising: a main structure, a light shade and a light source, the main structure including a rod and a base, and the light shade including a reflecting surface; wherein the rod is fixed on the base, the light shade is mounted on a top end of the rod and the reflecting surface thereof faces upward, the light source is disposed in the light shade and consisted of a plurality of single-packaged light emitting diodes each with a power of more than 12 W.

2. The LED floor lamp as claimed in claim 1, wherein the light source is consisted of three single-packaged light emitting diodes each with a power of more than 12 W.

3. The LED floor lamp as claimed in claim 1 further comprising a light-adjustment device for controlling the wave color of the light emitting diodes.

4. The LED floor lamp as claimed in claim 2 further comprising a light-adjustment device for controlling the wave color of the light emitting diodes.

5. The LED floor lamp as claimed in claim 1 further comprising an AC/DC plug.

6. The LED floor lamp as claimed in claim 2 further comprising an AC/DC plug.
